(19) United States
(12) Patent Application Publication
(10) Pub. No.: US 2008/0164184 A1
(43) Pub. Date: Jul. 10, 2008

(54) Fluidic sealing system for a wet drum magnetic separator

(76) Inventors: Peter G. Marston, Ipswich, MA (US); Ionel Wechsler, Framingham, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/893,350

(22) Filed: Aug. 15, 2007

Related U.S. Application Data
(60) Provisional application No. 60/879,373, filed on Jan. 9, 2007.

(51) Int. Cl. B03C 1/14

(52) U.S. Cl. 209/219

(57) ABSTRACT

A magnetic fluidic and a mechanical fluidic sealing system for a wet drum magnetic separator including a tank for receiving a flow of a mixture of magnetic and non magnetic particles, a rotating drum disposed in the tank, an array of permanent magnetic elements disposed inside the drum arranged in a fixed position relative to an azimuthal section of the drum for attracting the magnetic particles to the surface of the drum, and at least one seal disposed proximate each axial end of the array concentrically shaped and spaced from the surface of the drum and extending to a bottom wall of the tank for establishing a magnetic fluidic seal and/or a mechanical fluidic seal between the surface of the drum and an inner concentric surface of the seal that maintains the magnetic particles inside the magnetic field of the array and reduces end losses of the magnetic particles.

### RELATED APPLICATIONS

This application claims priority to provisional patent application Ser. No. 60/879,373, filed Jan. 9, 2007, incorporated by reference herein.

### FIELD OF THE INVENTION

This subject invention relates to a magnetic fluidic sealing system for a wet drum magnetic separator.

### BACKGROUND OF THE INVENTION

Wet drum magnetic separators are often used in the mining industry for recovering magnetite from iron ore. This is achieved by grinding the iron ore to a fine powder having particles sized typically less than about 70 microns. The fine grinding liberates the magnetite from other elements in the ore. The mixture of the magnetite and other elements is slurried in water and the slurry is fed to a wet magnetic drum separator where the more magnetic particles (e.g., magnetite) are extracted from the slurry leaving the less magnetic particles to be discharged as nonmagnetic tailings.

A typical wet drum magnetic separator includes an array of permanent magnetic elements disposed inside the lower portion of a cylindrical drum. The drum rotates in a tank continuously filled with the slurry-water mixture of magnetic and non-magnetic particles. The array of permanent magnetic elements inside the drum is kept in a fixed position close to the inner surface of the drum while the drum rotates in the tank. The more magnetic particles are extracted from the slurry by adhering to the surface of the drum in the region of the magnetic field created by the array of permanent magnets. The less or non-magnetic particles remain in the slurry. In operation, the feed slurry is fed continuously and the separation takes place typically with no interruption. The slurry depleted of the magnetic particles is directed to one discharge port and the magnetic particles are discharged into another discharge port as they leave the magnetic field of the array of permanent magnets.

The practical design limitations of a typical conventional magnetic drum do not allow the axial length of the array of magnetic elements inside the drum to be as long as the drum itself. The axial length of the drum also cannot be as wide as the tank. This results in spaces, typically about 1-2″, between the end of the array of permanent magnets and the end of the drum and between the end of the drum and the end of the tank. The feed slurry, however, is distributed over the full width of the tank and the surface of the drum. The result is regions between the end of the array of permanent magnets and the wall of the tank where the magnetic field provided by the array of permanent magnets cannot interact with the fluid particles in the mixture. This prevents the magnetic particles in the fluid located in those regions from being extracted from the slurry, a phenomenon known as end losses.

Ballasted flocculation and sedimentation processes and/or surface adsorption processes, such as those disclosed in U.S. Pat. Nos. 4,427,550 and 4,981,583 to Priestley et al. and U.S. Pat. No. 6,099,738 to Wechsler et al., each incorporated by reference herein, utilize a wet drum magnetic separator to recover magnetic ballasts, such as magnetite and similar type ballasts, from the effluent of these processes. End losses from the wet drum magnetic separators in these processes increase the processing costs.

### BRIEF SUMMARY OF THE INVENTION

It is therefore an object of this invention to provide a magnetic sealing system for a wet drum magnetic separator.

It is a further object of this invention to provide such a magnetic sealing system for a wet drum magnetic separator which reduces end losses.

It is a further object of this invention to provide such a magnetic sealing system for a wet drum magnetic separator which recovers more magnetic particles.

It is a further object of this invention to provide such a magnetic sealing system for a wet drum magnetic separator which increases yield.

It is a further object of this invention to provide such a magnetic sealing system for a wet drum magnetic separator which improves recovery of magnetic ballasts.

It is a further object of this invention to provide such a magnetic sealing system for a wet drum magnetic separator which reduces processing costs.

This invention results from the realization that a magnetic fluid sealing system for wet drum magnetic separator which reduces end loss and improves recovery of magnetic ballasts is effected, in one embodiment, with an array permanent magnetic elements disposed inside a rotating drum of a wet drum magnetic separator arranged in a fixed position relative to an azimuthal section of the drum for attracting the magnetic particles to the surface of the drum. At least one seal is disposed proximate each axial end of the array and is concentrically shaped and spaced from the surface of the drum and extends to a bottom wall of a tank and each seal establishes a magnetic fluidic seal between the surface of the drum and an inner concentric surface of the seal that maintains the magnetic particles inside the magnetic field of the array of permanent magnet to effectively reduce end losses and enhance recovery of the magnetic particles.

The subject invention, however, in other embodiments, need not achieve all these objectives and the claims hereof should not be limited to structures or methods capable of achieving these objectives.

This subject invention features a magnetic fluidic sealing system for a wet drum magnetic separator including a tank for receiving a flow of a mixture of magnetic and non magnetic particles, a rotating drum disposed in the tank, an array of permanent magnetic elements disposed inside the drum arranged in a fixed position relative to an azimuthal section of the drum for attracting the magnetic particles to the surface of the drum, and at least one seal disposed proximate each axial end of the array concentrically shaped and spaced from the surface of the drum and extending to a bottom wall of the tank for establishing a magnetic fluidic seal between the surface of the drum and an inner concentric surface of the seal that maintains the magnetic particles inside the magnetic field of the array and reduces end losses of the magnetic particles.

In a preferred embodiment, the at least one seal may include a ferromagnetic material. The ferromagnetic material may include carbon steel. The magnetic particles may include magnetite. At least a portion of the tank may be concentrically shaped. At least one seal may be concentrically shaped on one surface to closely match the shape of the surface of the drum and concentrically shaped on another surface to closely match the shape of concentrically shaped portion of the tank. The system may include a structural support configured to resist magnetic forces between the at least one seal and the array. The structural support may include at least one attachment to the tank. The magnetic fluidic seal may be permeable to the fluid carrying the flow of the mixture of magnetic and non magnetic particles. The fluid may include water. The magnetic fluidic seal may provide uniform fluidic pressure proximate each side of said at least one seal. The drum may rotate concurrent to the flow of the mixture of magnetic and non-magnetic particles. The drum may rotate counter-current flow of the mixture of magnetic and non-magnetic particles. The mixture of magnetic and non magnetic particles may be fed between opposing inner surfaces of the at least one seal.

This invention also features a magnetic fluidic sealing system for a wet drum magnetic separator including a tank for receiving a flow of a mixture of magnetic and non magnetic particles, a rotating drum disposed in the tank, an array of permanent magnetic elements disposed inside the drum arranged in a fixed position relative to an azimuthal section of the drum for attracting the magnetic particles to the surface of the drum, a non-magnetic particle discharge port proximate an azimuthal end of the array and inside a magnetic field of the array for removing non magnetic particles, a magnetic particle discharge port proximate the azimuthal end of the array and outside the magnetic field of the array for removing magnetic particles, and at least one seal disposed proximate each axial end of the array concentrically shaped and spaced from the surface of the drum and extending to a bottom wall of the tank for establishing a magnetic fluidic seal between the surface of the drum and an inner concentric surface of the seal that maintains the magnetic particles inside the magnetic field of the array and reduces end losses of the magnetic particles.

This invention further features a magnetic fluidic sealing system including a wet drum magnetic separator, and at least one seal disposed proximate each axial end of an array of permanent magnets inside a drum of the wet drum magnetic separator, the at least one seal concentrically shaped and spaced from the surface of the drum and extending to a bottom wall of the tank for establishing a magnetic fluidic seal between the surface of the drum and an inner concentric surface of the seal for maintaining the magnetic particles in a flow of a mixture of magnetic and non-magnetic particles inside the magnetic field of the array to reduce end losses of the magnetic particles.

This invention further features a mechanical fluidic sealing system for a wet drum magnetic separator including a tank for receiving a flow of a mixture of magnetic and non magnetic particles, a rotating drum disposed in the tank, an array of permanent magnetic elements disposed inside the drum arranged in a fixed position relative to an azimuthal section of the drum for attracting the magnetic particles to the surface of the drum, and at least one seal disposed proximate each axial end of the array concentrically shaped and spaced from the surface of the drum and extending to a bottom wall of the tank, the at least one seal including a mechanical sealing member for engaging the surface of the drum and establishing a mechanical fluidic seal between the surface of the drum and an inner concentric surface of the seal that maintains the magnetic particles inside the magnetic field of the array and reduces end losses of the magnetic particles.

In one embodiment, the sealing member may include a labyrinth seal, a solid rubber seal, or a flexible rubber seal. The sealing member may include a longitudinal opening for receiving a flow of water and a plurality of openings for establishing a seal between the surface of the drum and the mechanical sealing member to prevent the flow of magnetic and non-magnetic particles between the surface of the drum and the mechanical sealing member. At least a portion of the tank may be concentrically shaped. The at least one seal may be concentrically shaped on one surface to closely match the shape of the surface of the drum and concentrically shaped on another surface to closely match the concentrically shaped portion of the tank. The magnetic particles may include magnetite. The system may further include a structural support configured to resist magnetic forces between the at least one seal and the array. The structural support may include at least one attachment to the tank. The drum may rotate concurrent to the flow of the mixture of magnetic and non-magnetic particles. The drum may rotate counter-current flow of the mixture of magnetic and non-magnetic particles. The mixture of magnetic and non magnetic particles may be fed between opposing inner surfaces of the at least one seal and the sealing member. A source of water may be fed at a sufficient rate on one side of the at least one seal and the sealing member to establish a water seal for maintaining the mixture of magnetic and non-magnetic particles on the other side of the at least one seal and the sealing member and for providing uniform fluidic pressure proximate each side of the at least one seal and the sealing member.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1A is a three-dimensional view of a conventional wet drum magnetic separator;

FIG. 1B is a three-dimensional view showing the primary components of the conventional wet drum magnetic separator shown in FIG. 1A;

FIG. 1C is a three-dimensional view shown in further detail the array of permanent magnets shown in FIG. 1B;

FIG. 2 is a schematic side view showing the flow of the magnetic and non-magnetic particles for the wet drum magnetic separator shown in FIGS. 1A-1B;

FIG. 3 is a schematic front view showing the regions of end losses for the wet drum magnetic separator shown in FIGS. 1A-2;

FIG. 4 is a schematic side view of one embodiment of the magnetic fluidic sealing system for a wet drum magnetic separator of this invention;

FIG. 5 is a schematic front view showing the magnetic fluidic sealing system of this invention disposed between the drum and the tank shown in FIG. 4;

FIG. 6A is a schematic side view showing in further detail the location of the attachment of one of the seals to the tank shown in FIGS. 4-5;

FIG. 6B is a schematic side view showing the collection of magnetic particles in the space between the seal and the drum to establish the magnetic fluidic seal on each of the seals shown in FIG. 5;

FIG. 7 is a schematic front view showing one embodiment of the flow of fluid having magnetic and non-magnetic particles between the magnetic fluidic sealing system shown in FIGS. 4-6B;

FIG. 8 is a schematic side view of another embodiment of the magnetic fluidic sealing system for wet drum magnetic separator of this invention;

FIG. 9 is a schematic front view of one embodiment of a mechanical fluidic sealing system for a wet drum magnetic separator of this invention;

FIGS. 10A-10C are schematic side views of various embodiments of the mechanical sealing members shown in FIG. 9 of this invention;

FIG. 10D is a schematic side view of one embodiment of a mechanical sealing member used to establish a water seal between the surface of the drum and a flexible sealing member of this invention; and

FIG. 10E is a schematic side view showing the flow of a source of water through an orifice in the mechanical sealing member shown in FIG. 10D.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

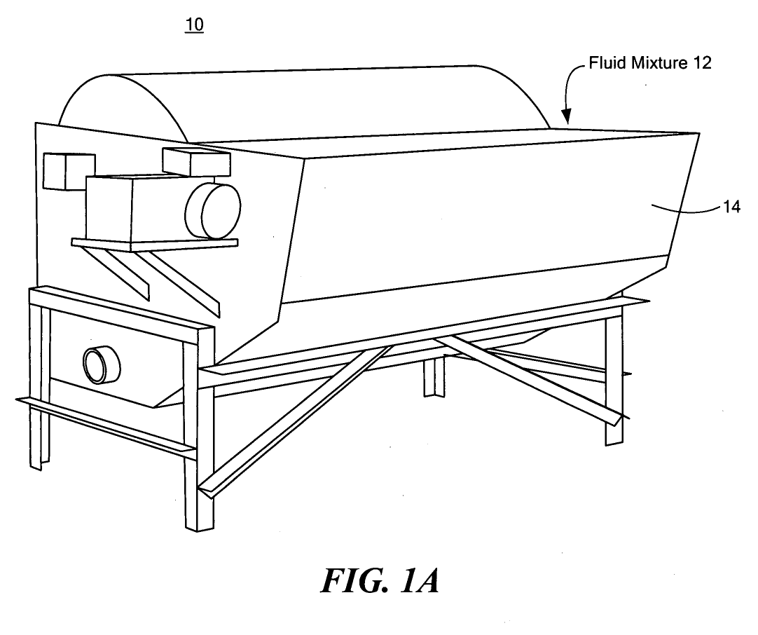

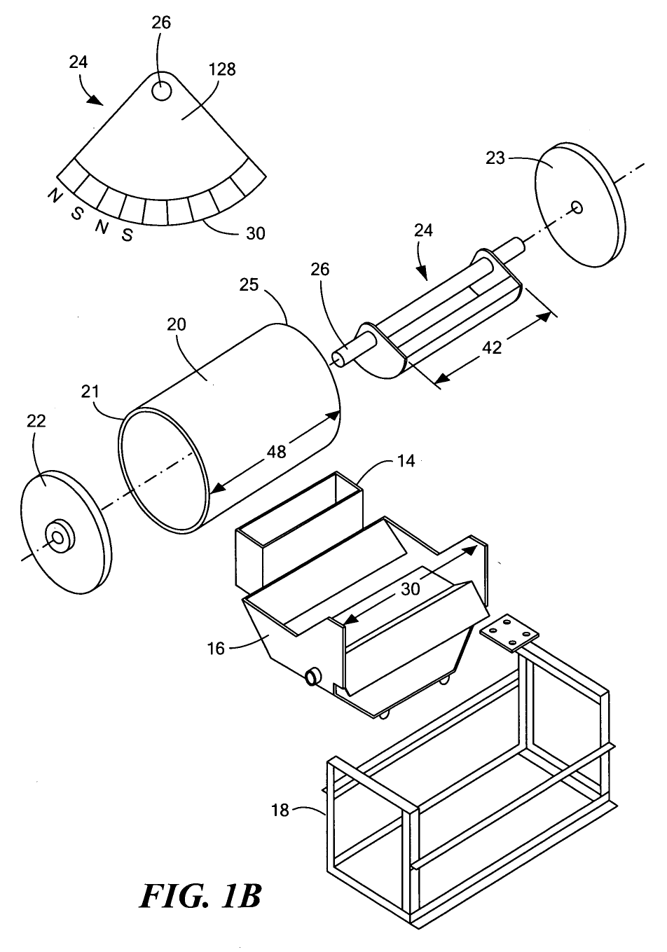

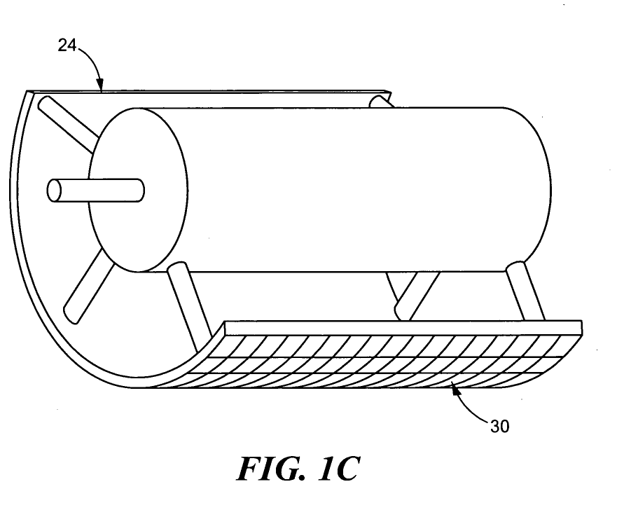

Conventional wet drum magnetic separator 10, FIG. 1A, is typically used to separate magnetic particles from non-magnetic particles in fluid mixture 12 which is fed into feed box 14. Fluid mixture 12 may be a feed slurry of magnetic and non-magnetic particles or an effluent having magnetic ballasts resulting from flocculation and sedimentation processes and/or adsorption processes. Wet drum magnetic separator 10 includes tank 16, FIG. 1B, with feed box 14. Tank 16 is supported by support frame 18. Drum 20 is disposed in tank 16. Array of permanent magnets 24 is disposed inside drum 20 and drum heads 22 and 23 are secured to ends 21 and 25, respectively. Array of permanent magnets 24 includes shaft 26 disposed through hanger 28 and a plurality of magnetic elements 30 attached to hanger 28. FIG. 1C shows in further detail one example of the axial and azimuthal arrangement of magnetic elements 30 on array of permanent magnets 24.

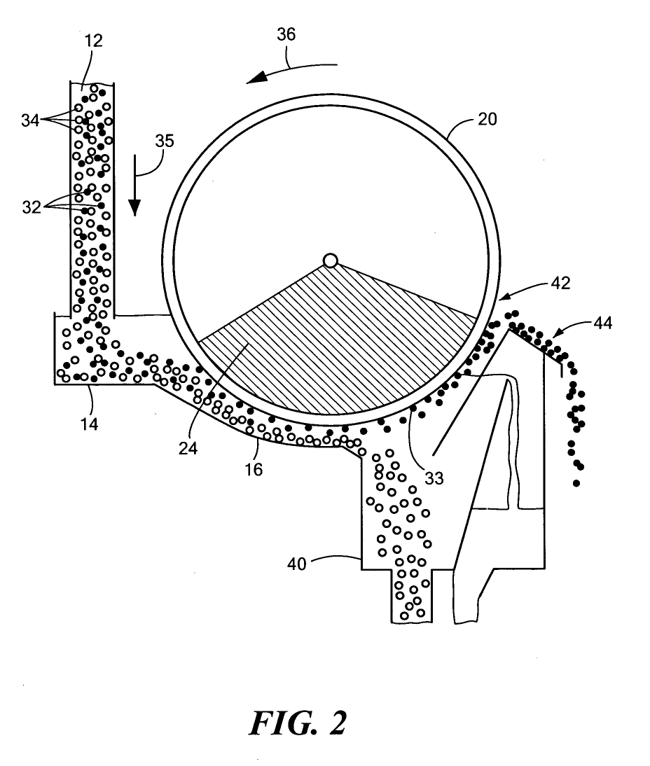

In operation, fluid mixture 12, FIG. 2, where like parts have been given like numbers, is fed into feed box 14. Fluid mixture 12 with magnetic particles 32 and non-magnetic particles 34 flows in the direction of arrow 35. In this example, drum 20 rotates concurrent to the flow of fluid mixture 12, indicated by arrow 36. Array of permanent magnets 24 is maintained in a fixed position relative to tank 16. As fluid mixture 12 having a mixture of magnetic particles 32 and non-magnetic particles 34 enters the magnetic field provided by array of permanent magnets 24, magnetic particles 32 adhere to the surface of drum 20, indicated at 33, while the non-magnetic particles 34 are discharged through discharge port 40. As magnetic particles 32 adhered to the surface of drum 20 leave the magnetic field provided by array of permanent magnets 24, indicated at 42, magnetic particles 32 are discharged into magnetic discharge port 44.

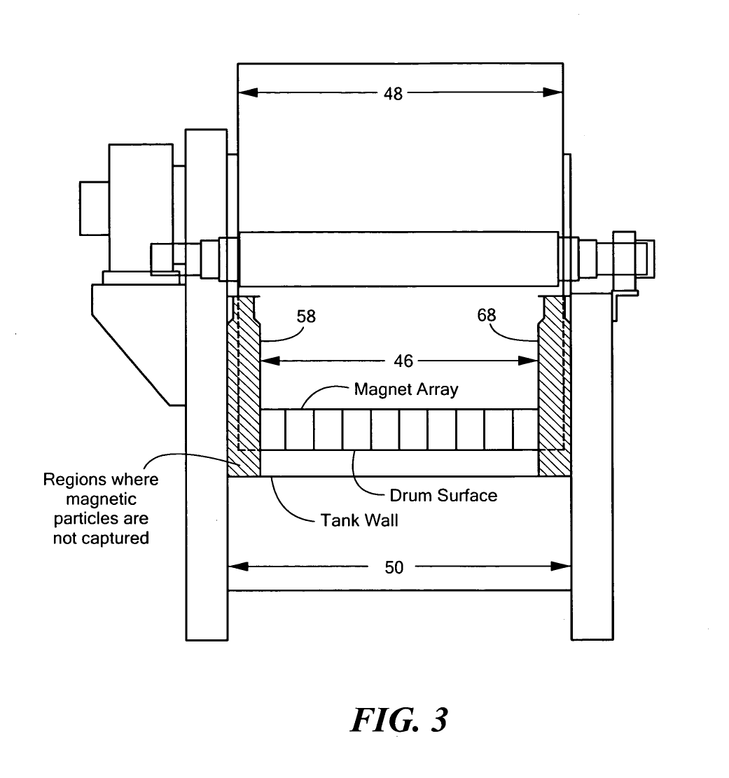

However, as discussed in the Background section above, the design limitations of conventional magnetic wet drum separator 10, FIGS. 1A-2 do not allow axial length 46, FIG. 1B of the array of permanent magnets 24, to be as long as the axial length 48 of magnetic drum 20. Similarly, axial length 48 of drum 20 with drum heads 22 and 23 cannot be as long as width 50 of tank 16. FIG. 3, where like parts have been given like numbers, is a front view of wet drum magnetic separator 10 showing axial length 46 of the array of permanent magnets 24, axial length 48 of drum 20, and the width 50 of tank 16. Thus, the design of wet drum magnetic separator 10 results in regions 58 and 60 between the end of array of permanent magnets 24 and the walls of tank 16 where the magnetic field provided by array of permanent magnets 24 cannot interact with the magnetic particles in fluid mixture 12, FIG. 2. This causes end losses in regions 58 and 60, FIG. 3, of the magnetic particles in fluid mixture 12.

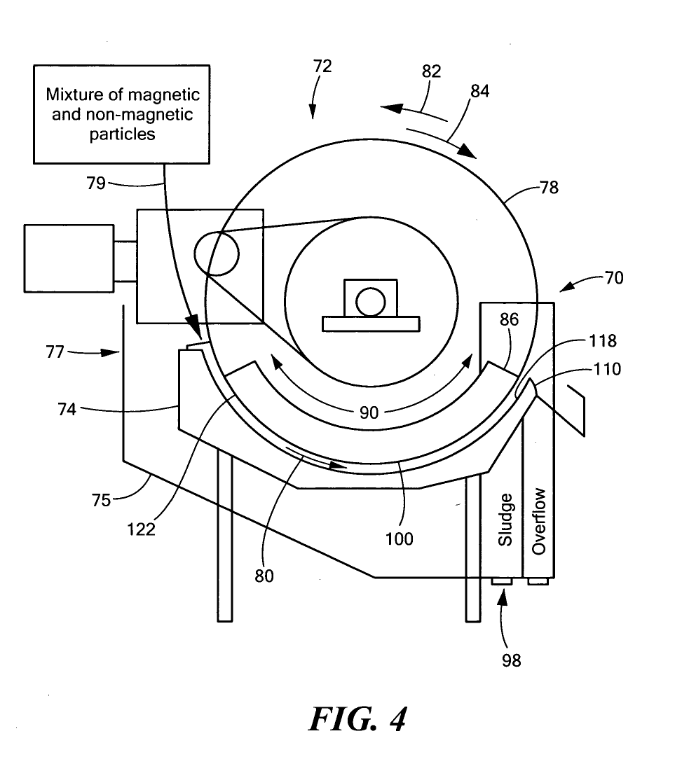

To overcome the problems associated with end loss, magnetic fluidic sealing system 70, FIG. 4, for wet drum magnetic separator 72 of this invention includes tank 74 disposed in support structure 75. Tank 74 receives a flow of a mixture of magnetic and non-magnetic particles 76 via feed box 77. Mixture 76 enters feed box 77 and flows in the direction indicated by arrows 79 and 80. Wet drum magnetic separator 72 has a similar design to wet drum magnetic separator 10, as discussed above with reference to FIGS. 1A-3. Wet drum magnetic separator 72 includes rotating drum 78 disposed in tank 74. In one design, drum 78 rotates concurrent to the flow of direction 80 of mixture of magnetic and non-magnetic particles 76, indicated by arrow 82. In other designs, drum 78 may rotate counter-current to direction 80 of the flow of mixture 76, indicated by arrow 84.

Wet drum magnetic separator 72 includes array of permanent magnets 86 having a similar design as array of permanent magnets 24, FIGS. 1B and 1C. Array of permanent magnets 86, FIG. 4, is disposed inside drum 78 and is arranged in a fixed position relative to an azimuthal section, e.g., section 90, of drum 78. Array of permanent magnets 86 attracts magnetic particles in mixture 76 to the surface 100 of drum 78, similarly as discussed above in reference to FIG. 2. Wet drum magnetic separator 72 operates similar to wet drum magnetic separator 10, FIG. 2, wherein magnetic particles in the flow of mixture of magnetic and non-magnetic particles 76, FIG. 4, are attracted to the surface of drum 100 by the magnetic field provided by array of permanent magnets 86, while the non-magnetic particles are discharged through non-magnetic discharge port 98. The magnetic particles in mixture 76 adhere to surface 100 of drum 78 and are discharged through magnetic discharge port 102 once they leave the magnetic field provided by array of permanent magnets 86. Similar as described above, wet drum magnetic separator 72 has end losses in regions 58 and 60, FIG. 3.

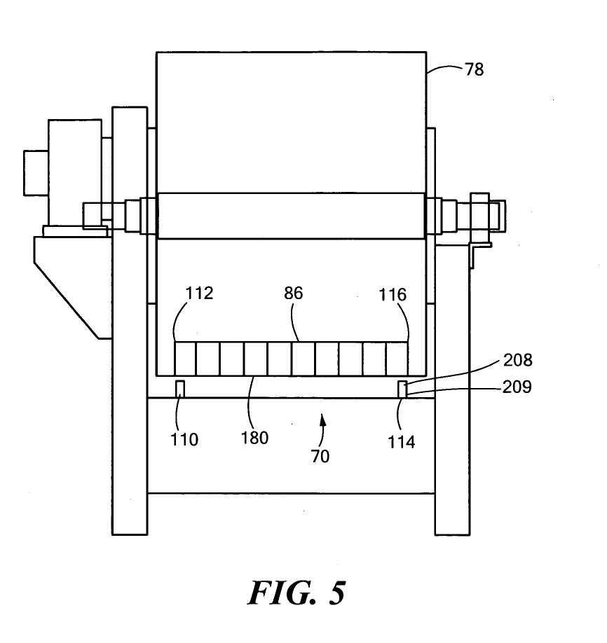

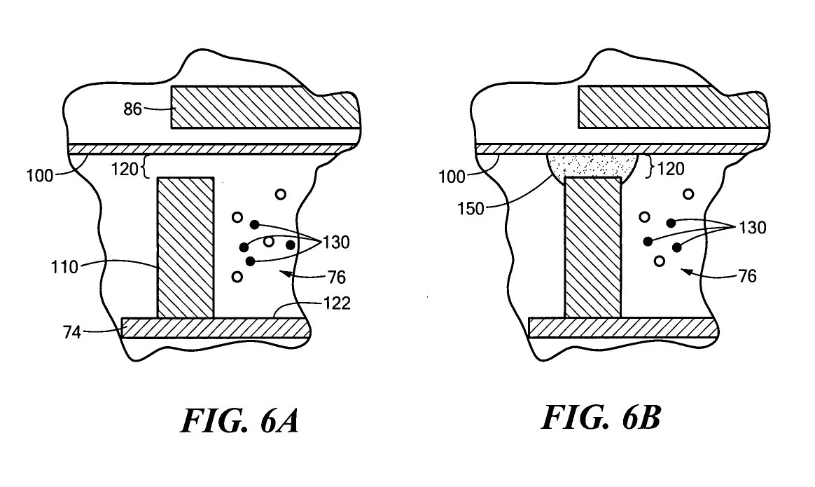

To overcome the problems associated with end losses in regions 58 and 60, FIG. 3, magnetic fluidic sealing system 70, FIG. 4, of this invention includes seal 110 disposed proximate to axial end 112, FIG. 5, of array of permanent magnets 86 and seal 114 disposed proximate axial end 116 of array of permanent magnets 86. Seals 110 and 114 are each concentrically shaped on one surface, e.g., surface 118, FIG. 4, to closely match the shape of surface 100 of drum 78. Seals 110 and 114 are spaced from surface 100, as shown by space 120, FIG. 6A. Each of seal 110 and 114, FIG. 5, extends to a bottom wall, e.g., bottom wall 122, FIG. 4, of tank 74 which provides structural support for the seals that resists magnetic forces between seals 110 and 114 and the permanent magnets 86. Seals 110 and 114 may be shaped as shown in FIG. 4 to fit bottom wall 122 of tank 74. In other designs, tank 74 may not be shaped as shown in FIG. 4 and may have a concentric shape. In this design, seals 110 and 114 have a concentric shape on both surfaces to fit into tank 74.

FIG. 6A shows in further detail an example of seal 110 affixed to bottom wall 122 of tank 74 and space 120 between surface 100 of drum 78 and concentrically shaped surface 118 of seal 110. The magnetic field provided by array of permanent magnets 86 interacts with seal 110, which is typically made of a ferro-magnetic material, such as carbon steel, or similar type of materials known to those skilled in the art, causing a region of magnetic field gradient to be created between array of permanent magnets 86 and seal 110. The magnetic gradient traps magnetic particles, e.g., magnetic particles 130 in fluid mixture 76, in space 120 between surface 100 of drum 78 and surface 118 of seal 110. The trapped magnetic particles 130 in space 120 establish magnetic fluidic seal 150, FIG. 6B. In a similar manner, a magnetic fluidic seal 150 is established on seal 114, FIG. 5. Magnetic fluidic seal 150 is permeable to the flow of fluid mixture 76, e.g., the water in fluid mixture 76. Therefore, magnetic fluid seal 150 provides uniform hydraulic pressure on both sides of seals 110 and 116, FIG. 5. This prevents seals 110 and 116 from being destroyed during high flow operation of wet drum magnetic separator 72.

The result is magnetic fluidic sealing system 70 traps the magnetic particles 130 in mixture 76 in space 120 between seals 110 and 114 and the surface 100 of the drum 78. This effectively reduce end losses of the magnetic particles, e.g., in regions 58 and 60, FIG. 3, of mixture of magnetic and non-magnetic particles 76, FIGS. 4-6B. This increases the yield of the magnetic particles in the mixture of magnetic and non-magnetic particles, e.g., magnetite and similar type magnetic materials known to those skilled in the art, and enhances recovery of magnetic particles in ballasted flocculation and sedimentation processes and/or surface adsorption processes, which reduces processing costs.

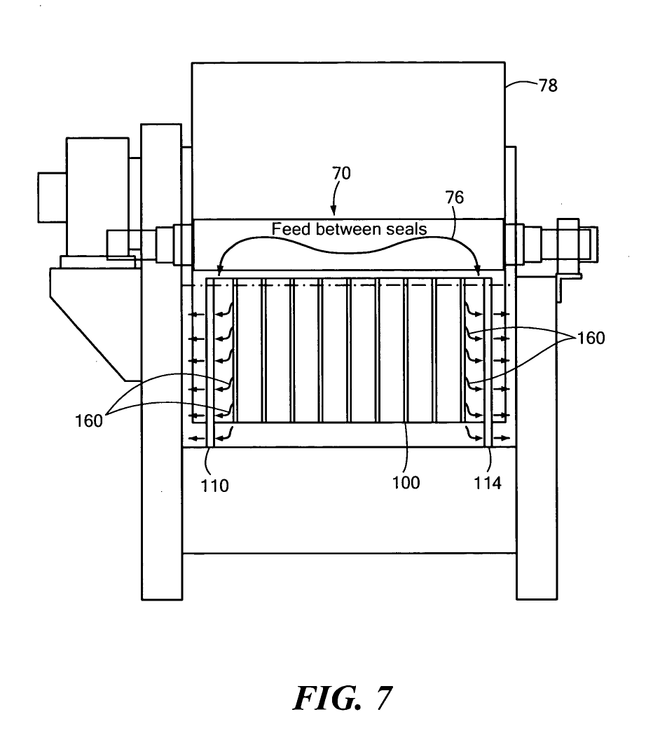

FIG. 7 shows one example of the feed of the flow of mixture 76 of magnetic and non-magnetic particles. In this example, mixture 76 is fed between seals 110 and 114 which have each have established a magnetic fluidic seal, 150, as discussed above, to trap magnetic particles in mixture 76 between seals 110 and 114 and surface 100 of drum 78. Arrows 160 indicate the magnetic fluidic seals established by seals 110 and 114 which are permeable to a fluid, e.g., water in mixture 76, thus providing uniform pressure on each side of seals 110 and 114. The result is that end losses are significantly reduced thus increasing the yield and recovery of valuable magnetic particles.

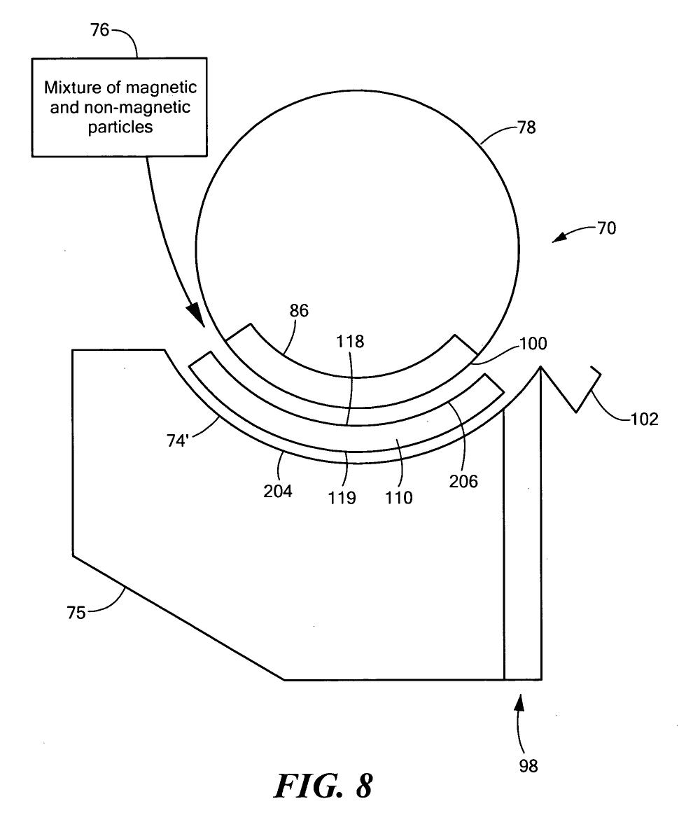

In one embodiment, tank 74′, FIG. 8, where like parts have been given like numbers, includes concentrically shaped portion 204. In this design, seal 110 is concentrically shaped on surface 118 to closely match the shape of surface 100 of drum 78 as discussed above, and concentrically shaped on surface 119 to closely match the shape of concentrically shaped portion 204 of tank 74′. Seal 114, FIG. 5, is similarly concentrically shaped on surfaces 208 and 209.

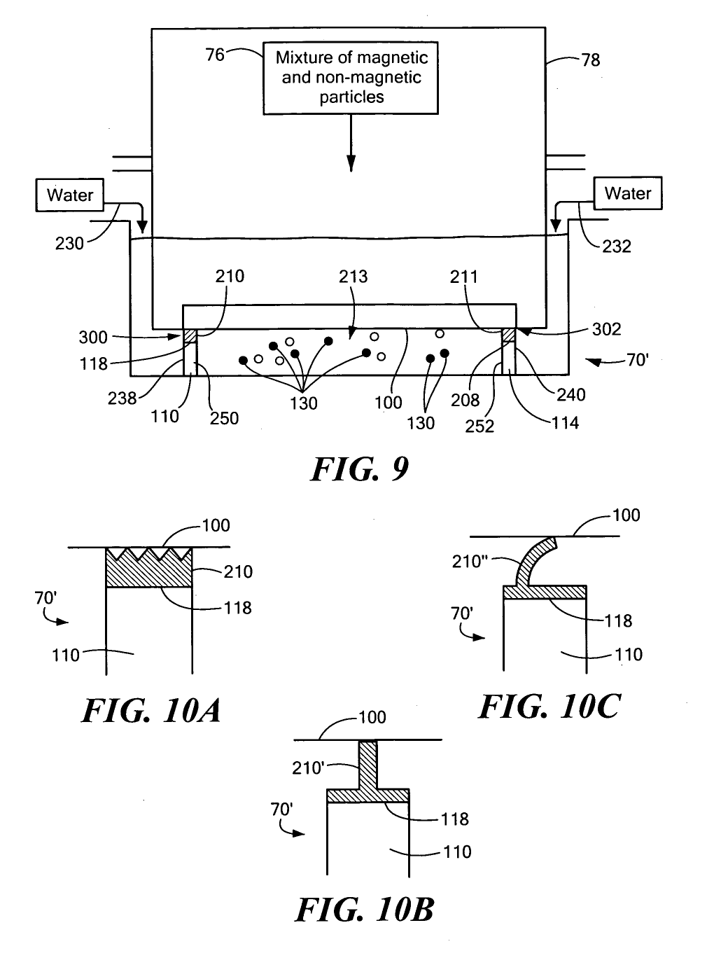

Although, as discussed above with reference to FIGS. 4-6B, magnetic fluidic sealing system 70 includes seals 110 and 114 with array of permanent magnets 86 that establish magnetic fluidic seal 150 to prevent end losses, this is not a necessary limitation of this invention. In another embodiment, mechanical fluidic sealing system 70′, FIG. 9, where like parts have been given like numbers, for wet drum magnetic separator 72 includes mechanical sealing member 210 attached to seal 110 and mechanical sealing member 211 attached to seal 114. Mechanical sealing members 220 and 211 engage surface 100 of drum 78 and establish a mechanical fluidic seal between surface 100 of drum 78 and inner concentric surface 118 of seal 110 and inner concentric surface 208 of seal 114 that maintains magnetic particles, e.g., magnetic particles 130, between seals 110 and 114 to reduce end losses. Sealing members 210 and 211 are typically made of hardened rubber.

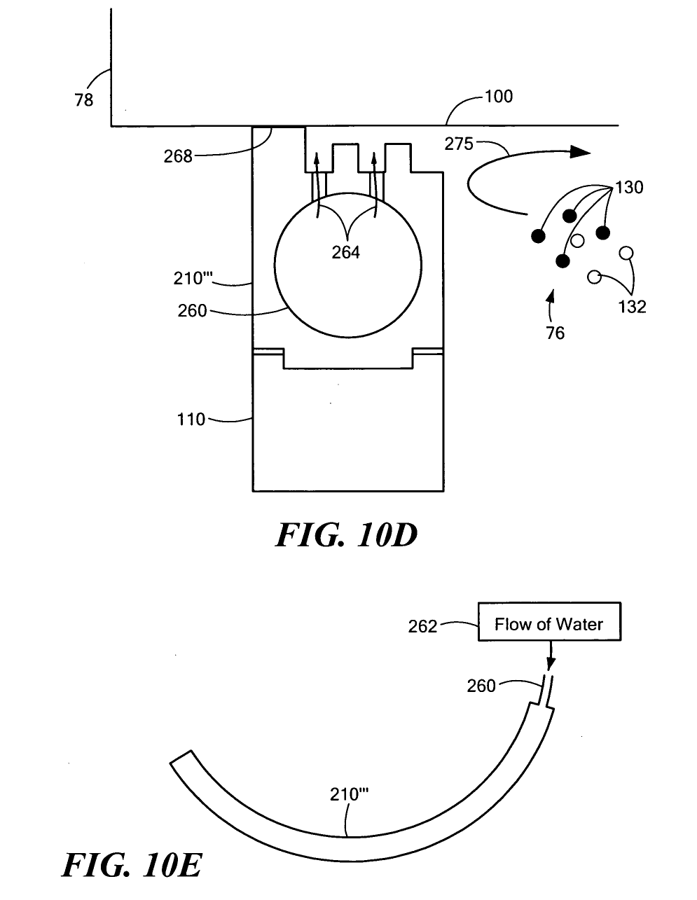

In one design, mechanical sealing member 210 may be a labyrinth type seal as shown FIG. 10A. In other designs, mechanical sealing member 210 may be a solid rubber sealing member, e.g., mechanical sealing member 210′, FIG. 10B. In another design, mechanical sealing member 210 may be a flexible rubber seal, e.g., mechanical sealing member 210″, FIG. 10C. In yet another design, mechanical sealing member 210′″, FIG. 10D, includes longitudinal opening 260 for receiving a flow of water, e.g., flow of clean water, 262, FIG. 10E, and a plurality of radial openings 264, FIG. 10D, which establish water seal 266 between surface 100 of drum 78 and mechanical sealing member 210′″. Water seal 266 prevents the flow of magnetic particles 130 and non-magnetic particles 132 in mixture 76 from flowing between surface 100 of drum 76 and surface 268 of mechanical sealing member 210′″, as shown by arrow 270. FIG. 10E shows an example of flow of water 262 entering orifice 260 as described above with reference to FIG. 10D. Mechanical sealing member 211 may similarly include any of the designs discussed above with reference to FIGS. 10A-10E.

In one embodiment, flow of water 230, FIG. 9 is introduced on side 238 of seal 110 and flow of water 232 is introduced on side 240 of seal 114 to establish water seal 300 between sealing member 210 and surface 100 of drum 78 and water seal 302 between sealing member 211 and surface 100 of drum 78. Water seals 300 and 302 maintain mixture 76 of magnetic particles 130 and non-magnetic particles 132 between side 250 of seal 110 with sealing member 210 and side 252 of seal 114 with sealing member 211. Flow of water, 230 and 232, also provides uniform fluidic pressure proximate sides 238 and 250 of seal 110 and sides 240 and 252 of seal 114.

Although as discussed above with reference to FIGS. 9-10C, seals 110 and 114 include mechanical sealing member 210 and 211, respectively, to establish a mechanical fluidic seal, this is not a necessary limitation of this invention, as any one of seals 110 or 114 may include mechanical sealing member 210 to establish a mechanical fluidic seal and the other of seals 110 and 114 may include magnetic fluidic seal 150, as discussed above with reference to FIGS. 4-6B.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A magnetic fluidic sealing system for a wet drum magnetic separator comprising:
a tank for receiving a flow of a mixture of magnetic and non magnetic particles;
a rotating drum disposed in the tank;
an array of permanent magnetic elements disposed inside the drum arranged in a fixed position relative to an azimuthal section of the drum for attracting the magnetic particles to the surface of the drum; and
at least one seal disposed proximate each axial end of the array concentrically shaped and spaced from the surface of the drum and extending to a bottom wall of the tank for establishing a magnetic fluidic seal between the surface of the drum and an inner concentric surface of the seal that maintains the magnetic particles inside the magnetic field of the array and reduces end losses of the magnetic particles.

2. The system of claim 1 in which the at least one seal includes a ferromagnetic material.

3. The system of claim 1 in which the ferromagnetic material includes carbon steel.

4. The system of claim 1 in which at least a portion of the tank is concentrically shaped.

5. The system of claim 4 in which the at least one seal is concentrically shaped on one surface to closely match the shape of the surface of the drum and concentrically shaped on another surface to closely match the shape of the concentrically shaped portion of the tank.

6. The system of claim 1 in which the magnetic particles include magnetite.

7. The system of claim 1 further including a structural support configured to resist magnetic forces between the at least one seal and the array.

8. The system of claim 7 in which the structural support includes at least one attachment to the tank.

9. The system of claim 1 in which the magnetic fluidic seal is permeable to the fluid carrying the flow of the mixture of magnetic and non magnetic particles.

10. The system of claim 9 in which the fluid includes water.

11. The system of claim 9 in which the magnetic fluidic seal provides uniform fluidic pressure proximate each side of said at least one seal.

12. The system of claim 1 in which the drum rotates concurrent to the flow of the mixture of magnetic and non-magnetic particles.

13. The system of claim 1 in which the drum rotates counter-current flow of the mixture of magnetic and non-magnetic particles.

14. The system of claim 1 in which the mixture of magnetic and non magnetic particles is fed between opposing inner surfaces of the at least one seal.

15. A magnetic fluidic sealing system for a wet drum magnetic separator comprising:
a tank for receiving a flow of a mixture of magnetic and non magnetic particles;
a rotating drum disposed in the tank;
an array of permanent magnetic elements disposed inside the drum arranged in a fixed position relative to an azimuthal section of the drum for attracting the magnetic particles to the surface of the drum;
a non magnetic particle discharge port proximate an azimuthal end of the array and inside a magnetic field of the array for removing non magnetic particles;
a magnetic particle discharge port proximate the azimuthal end of the array and outside the magnetic field of the array for removing magnetic particles; and
at least one seal disposed proximate each axial end of the array concentrically shaped and spaced from the surface of the drum and extending to a bottom wall of the tank for establishing a magnetic fluidic seal between the surface of the drum and an inner concentric surface of the seal that maintains the magnetic particles inside the magnetic field of the array and reduces end losses of the magnetic particles.

16. A magnetic fluidic sealing system comprising:
a wet drum magnetic separator; and
at least one seal disposed proximate each axial end of an array of permanent magnets inside a drum of the wet drum magnetic separator, the at least one seal concentrically shaped and spaced from the surface of the drum and extending to a bottom wall of the tank for establishing a magnetic fluidic seal between the surface of the drum and an inner concentric surface of the seal for maintaining the magnetic particles in a flow of a mixture of magnetic and non-magnetic particles inside the magnetic field of the array to reduce end losses of the magnetic particles.

17. A mechanical fluidic sealing system for a wet drum magnetic separator comprising:
a tank for receiving a flow of a mixture of magnetic and non magnetic particles;
a rotating drum disposed in the tank;
an array of permanent magnetic elements disposed inside the drum arranged in a fixed position relative to an azimuthal section of the drum for attracting the magnetic particles to the surface of the drum; and
at least one seal disposed proximate each axial end of the array concentrically shaped and spaced from the surface of the drum and extending to a bottom wall of the tank, the at least one seal including a mechanical sealing member for engaging the surface of the drum and establishing a mechanical fluidic seal between the surface of the drum and an inner concentric surface of the seal that maintains the magnetic particles inside the magnetic field of the array and reduces end losses of the magnetic particles.

18. The system of claim 17 in which the sealing member includes a labyrinth seal.

19. The system of claim 17 in which the sealing member includes a solid rubber seal.

20. The system of claim 17 in which the sealing member includes a flexible rubber seal.

21. The system of claim 17 in which the sealing member includes a longitudinal opening for receiving a flow of water and a plurality of radial openings for establishing a water seal between the surface of the drum and the flexible sealing member to prevent the flow of magnetic and non-magnetic particles between the surface of the drum and the mechanical sealing member.

22. The system of claim 17 in which at least portion of the tank is concentrically shaped.

23. The system of claim 22 in which the at least one seal is concentrically shaped on one surface to closely match the shape of the surface of the drum and concentrically shaped on another surface to closely match the concentrically shaped portion of the tank.

24. The system of claim 17 in which the magnetic particles include magnetite.

25. The system of claim 17 further including a structural support configured to resist magnetic forces between the at least one seal and the array.

26. The system of claim 25 in which the structural support includes at least one attachment to the tank.

27. The system of claim 17 in which the drum rotates concurrent to the flow of the mixture of magnetic and non-magnetic particles.

28. The system of claim 17 in which the drum rotates counter-current flow of the mixture of magnetic and non-magnetic particles.

29. The system of claim 17 in which the mixture of magnetic and non magnetic particles is fed between opposing inner surfaces of the at least one seal and the sealing member.

30. The system of claim 29 in which a source of water is fed at a sufficient rate on one side of the at least one seal and the sealing member to establish a water seal for maintaining the mixture of magnetic and non-magnetic particles on the other side of the at least one seal and the sealing member and for providing uniform fluidic pressure proximate each side of the at least one seal and the sealing member.
